(19) United States
(12) Patent Application Publication
(10) Pub. No.: US 2012/0013799 A1
(43) Pub. Date: Jan. 19, 2012

(54) IMAGE DISPLAY DEVICE AND IMAGE PROCESSING METHOD

(76) Inventor: Syuuji Murayama, Tokyo (JP)

(21) Appl. No.: 13/138,754

(22) PCT Filed: Mar. 30, 2009
(86) PCT No.: PCT/JP2009/056531

§ 371 Date: Sep. 23, 2011

(51) Int. Cl. H04N 7/00

(52) U.S. Cl. 348/468; 348/E07.033

(57) ABSTRACT

An image display device according to the present invention includes a caption signal decoding section that extracts a caption signal from an image signal that is input; an image extraction section that extracts image data other than the caption signal from the image signal; a correction pixel conversion section that changes an image display area for the image data that are input from the image extraction section according to an instruction that causes a shape or size of the image display area to be changed, that outputs corrected image data that are image data in which the image display area has been changed, that restricts changing the image display area based on a correction amount that is input, and that outputs corrected image data that are image data in which changing of the image display area has been restricted; an image display section that outputs an image of combined image data that are data in which the caption signal that has been output from the caption signal decoding section and the correction image data that have been output from the correction pixel conversion section are combined; a display area detection section that detects a caption display area that is a display area for textual information of the caption signal and the image display area from the combined image data that are input and outputs the combined image data if the caption display area does not fit into the image display area; and a correction information processing section that computes the correction amount to enable the caption display area to fit into the image display area for the combined image data received from the display area detection section and sends the correction amount to the correction pixel conversion section.

### TECHNICAL FIELD

The present invention relates to an image display device and an image processing method.

### BACKGROUND ART

In radio wave broadcasting and package media such as CD-ROMs and DVDs that are used in areas such as North America, textual information is superimposed on an image signal during its vertical retrace period so as to provide hearing-impaired persons with information of speech and narration of programs. The textual information is displayed such that it is superimposed on an image like a subtitle of a movie. This textual information is referred to as a closed caption. In the following, a signal that contains information of a closed caption is referred to as a closed caption signal.

When the user watches an image containing textual information on a television receiver, if it enlarges or reduces the image corresponding to the size of its screen, textual information of the closed caption signal may disappear from the screen.

Exemplary techniques that solve such a problem are disclosed in JP6-268913A Publication, JP10-93932 Publication, and JP2003-339031 Publication.

### DISCLOSURE OF THE INVENTION

A projector of a particular type, which is a kind of an image display device, has a function that enlarges and reduces an image projected on a screen. A projector of another type has an image output plane that is not vertical to the screen and is provided with a function that forms an output image in a trapezoidal shape on the screen even if the projector is tilted such that an image projected on the screen appears in a rectangular shape.

When an image that is output from the projector is formed in a trapezoidal shape, textual information of the closed caption signal is sometimes displayed such that it protrudes from the image. Along with the projector, when the function that forms an image in a trapezoidal shape and outputs the resultant image is applied to the display device, it is likely that such a problem will occur.

An exemplary object of the present invention is to provide an image display device that can prevent a problem in which a subtitle disappears when an image is output in a trapezoidal shape from occurring.

An image display device according to an exemplary aspect of the present invention includes a caption signal decoding section that extracts a caption signal from an image signal that is input; an image extraction section that extracts image data other than the caption signal from the image signal; a correction pixel conversion section that changes an image display area for the image data that are input from the image extraction section according to an instruction that causes a shape or size of the image display area to be changed, that outputs corrected image data that are image data in which the image display area has been changed, that restricts changing the image display area based on a correction amount that is input, and that outputs corrected image data that are image data in which changing of the image display area has been restricted; an image display section that outputs an image of combined image data that are data in which the caption signal that has been output from the caption signal decoding section and the correction image data that have been output from the correction pixel conversion section are combined; a display area detection section that detects a caption display area that is a display area for textual information of the caption signal and the image display area from the combined image data that are input and outputs the combined image data if the caption display area does not fit into the image display area; and a correction information processing section that computes the correction amount to enable the caption display area to fit into the image display area for the combined image data received from the display area detection section and sends the correction amount to the correction pixel conversion section.

An image processing method of an image display device according to an exemplary aspect of the present invention includes extracting a caption signal and image data other than the caption signal from an image signal that is input; generating first corrected image data that are image data in which an image display area that is a display area of an image of the image data is changed according to an instruction that causes a shape or a size of the image display area to be changed; detecting the image display area and a caption display area that is an area in which textual information of the caption signal is displayed from combined image data in which the first correction image data and the caption signal are combined; computing a correction amount to enable the caption display area to fit into the image display area if the caption display area does not fit the image display area; generating second corrected image data that are image data in which changing of the image display area is restricted based on the correction amount; and outputting combined image data in which the caption signal and the second combined image data are combined.

### BRIEF DESCRIPTION OF DRAWINGS

FIG. 1 is a block diagram showing an exemplary structure of a projector according to a first embodiment.

FIG. 2 is a block diagram showing an exemplary structure of an image signal processing section shown in FIG. 1.

FIG. 3 is a flow chart showing an operating procedure of the projector according to the first embodiment.

FIG. 4 is a schematic diagram describing a correcting method of an image display area according to the first embodiment.

FIG. 5 is a block diagram showing an exemplary structure of an image signal processing section according to a second embodiment.

FIG. 6 is a block diagram showing an exemplary structure of an image signal processing section according to a third embodiment.

FIG. 7 is a block diagram showing principal portions of a projector according to a fourth embodiment.

### DESCRIPTION OF REFERENCE NUMERALS

101 projector
103 caption signal decoding section
104 image extraction section
105 correction pixel conversion section
106 image display section
107 display area detection section
108 correction information processing section
110 image signal processing section
112 operation section

### BEST MODES THAT CARRY OUT THE INVENTION

Embodiments as regards image display devices of the present invention will be described. Although image display devices include display devices for personal computers and TV receivers, projectors, and so forth, image display devices will be described as projectors in embodiments. These embodiments are applied not only to closed captions, but also to ordinary subtitles. In the following, ordinary subtitles including closed captions are simply referred to as captions.

### First Embodiment

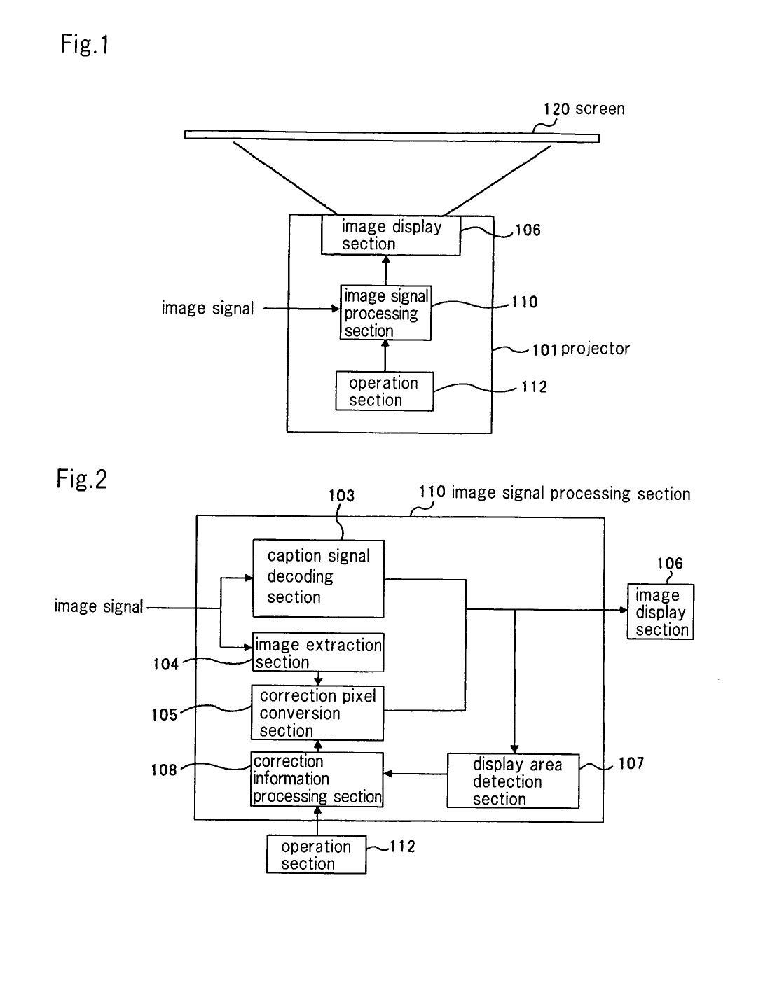

Here, the structure of a projector according to this embodiment will be described. FIG. 1 is a block diagram showing an exemplary structure of the projector according to this embodiment.

As shown in FIG. 1, projector 101 has image display section 106, image signal processing section 110, and operation section 112. Devices that input an image signal to image signal processing section 110 are information processing devices for personal computers, television receivers, DVD players, and so forth. Image signals are, for example, RGB format component image signals.

Image display section 106 has a light source (not shown) that projects an image generated by a light bulb on screen 120, a plurality of lenses, and a focus adjustment section (not shown) that moves the lenses along the optical axis.

Operation section 112 is provided with a plurality of control buttons and switches that cause projector 101 to operate. Operation section 112 also includes a remote controller that sends user's instructions to the projector's main body through infrared communication. By operating operation section 112, the user can change at least either the shape or the size of a display area of an image. The shape may be changed from a rectangle to a trapezoid. The size may be changed by enlarging the display area of an image or reducing it.

Here, image signal processing section 110 shown in FIG. 1 will be described in detail. FIG. 2 is a block diagram showing an exemplary structure of the image signal processing section according to this embodiment.

As shown in FIG. 2, image signal processing section 110 has caption signal decoding section 103, image extraction section 104, correction pixel conversion section 105, correction information processing section 108, and display area detection section 107. When an image signal containing a caption signal is input to projector 101, the image signal is input to each of caption signal decoding section 103 and image extraction section 104. The caption signal is textual information that is displayed such that it is superimposed on an image.

Caption signal decoding section 103 extracts the caption signal from the image signal during its vertical retrace period and converts the caption signal into caption data that are data based on the caption signal. Image extraction section 104 extracts image data that excludes the textual information and that are displayed on the screen from the image signal and sends the extracted image data to correction pixel conversion section 105.

Caption signal decoding section 103 and correction pixel conversion section 105 output data such that they cause caption data and image data of the same image signal to synchronize with each other. The caption data that are output from caption signal decoding section 103 and the image data that are output from correction pixel conversion section 105 are combined. Hereinafter, the combined data are referred to as combined image data. The combined image data are input to each of image display section 106 and display area detection section 107.

A display area for textual information of an image of the combined image data is referred to as the caption display area, whereas a display area for image data that are output from correction pixel conversion section 105 are referred to as the image display area.

When the combined image data are input to display area detection section 107, it compares the caption display area with the image display area and determines whether or not the caption display area protrudes from the image display area. If display area detection section 107 determines that the caption display area protrudes from the image display area, display area detection section 107 sends the combined image data to correction information processing section 108, but if the caption display area fits into the image display area, display area detection section 107 does not transmit the combined image data to correction information processing section 108.

When an instruction that causes the screen to be reduced, enlarged, or formed in a trapezoidal shape is input from operation section 112 to correction information processing section 108, correction information processing section 108 notifies correction pixel conversion section 105 of the contents of the instruction. When correction information processing section 108 receives the combined image data from display area detection section 107, correction information processing section 108 computes a correction amount to enable the caption display area to fit into the image display area and sends information of the correction amount to correction pixel conversion section 105.

Correction pixel conversion section 105 converts pixels of the image data received from image extraction section 104 into those corresponding to a resolution based on a predetermined standard. The standard is for example XGA (eXtended Graphics Array). When correction pixel conversion section 105 receives the instruction that causes the screen to be reduced, enlarged, or formed in a trapezoidal shape from correction information processing section 108, correction pixel conversion section 105 converts pixels of the original image data into those of image data in which the image display area has been changed based on the contents of the instruction. Here, a simple specific example will be described. When correction pixel conversion section 105 receives an instruction that causes a rectangular image display area of the image data to be changed to a trapezoidal image display area from correction information processing section 108, correction pixel conversion section 105 generates image data in which pixels for the rectangular image display area have been converted into those for the trapezoidal image display area.

When correction pixel conversion section 105 receives information of the correction amount from correction information processing section 108, correction pixel conversion section 105 generates image data in which pixels of the image data, which were changed based on the contents of the instruction, have been converted into those that restrict the image display area corresponding to the correction amount. Correction pixel conversion section 105 outputs image data in which pixels have been converted. Image data in which pixels have been converted are equivalent to corrected image data.

Image display section 106 is provided with fixed pixel panels (not shown) corresponding to individual colors of RGB. In the following, for simplicity, one fixed pixel panel will be described. When the combined image data are input from image signal processing section 110 to the fixed pixel panel, image display section 106 projects an image of the combined image data on screen 120.

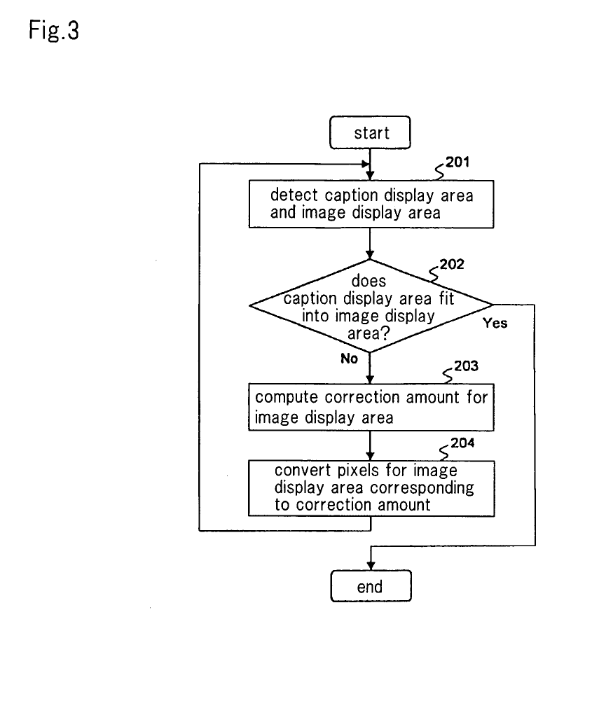

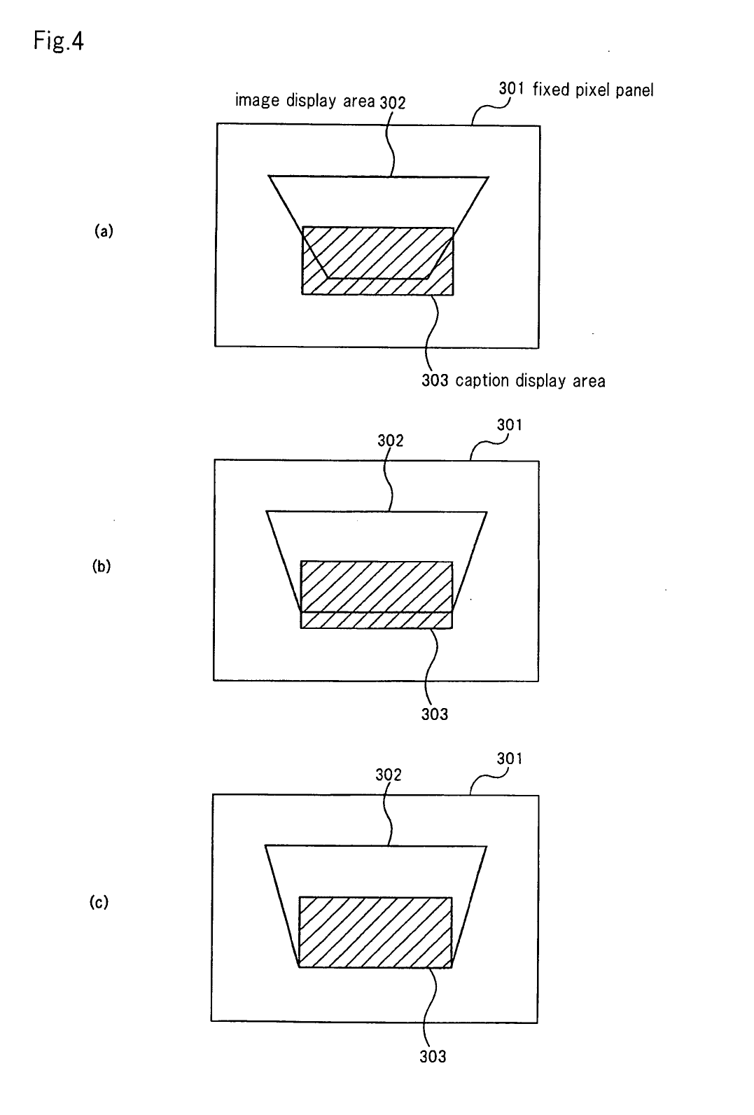

Next, operation of the correction process of image signal processing section 110 for the image display area will be described. FIG. 3 is a flow chart showing the procedure for the operation of an image signal processing section according to this embodiment. FIG. 4 is a schematic diagram describing a correction method for the image display area according to this embodiment. FIG. 4 shows the case in which an image of the combined image data is displayed on the fixed pixel panel.

An image signal containing a caption signal is input to each of caption signal decoding section 103 and image extraction section 104 of projector 101. Caption signal decoding section 103 extracts textual information from the image signal during its vertical retrace period and outputs caption data that are data of the extracted textual information. Image extraction section 104 extracts image data other than the textual information from the image signal and outputs the extracted image data to correction pixel conversion section 105. In this stage, since correction pixel conversion section 105 has not received the information of the correction amount from correction information processing section 108, correction pixel conversion section 105 outputs the image data that have been input.

The caption data that are output from caption signal decoding section 103 and the image data that are output from correction pixel conversion section 105 are combined and then the combined image data are input to each of image display section 106 and display area detection section 107. When the combined image data are input to fixed pixel panel 301, image display section 106 projects an image of the combined image data on screen 102. Display area detection section 107 detects the caption display area and the image display area from the received combined image data (at step 201), determines whether or not the caption display area fits into the image display area (at step 202), and outputs no data if the caption display area fits into the image display area.

The user watches an image projected on screen 102 and changes the shape or size of the image. In this example, it is assumed that the user operates operation section 112 so as to input an instruction that causes the image projected on screen 102 to be formed in a trapezoidal shape. At this point, as represented on fixed pixel panel 301 shown in FIG. 4(a), image display area 302 becomes a trapezoidal shape in which the lower base is shorter than the upper base and thereby rectangular caption display area 303 protrudes from image display area 302. The newly combined image data are processed according to the flow chart shown in FIG. 3.

Display area detection section 107 detects caption display area 303 and image display area 302 from the combined image data that have been input (at step 201). Thereafter, display area detection section 107 determines whether or not caption display area 303 fits into image display area 302 (at step 202). If display area detection section 107 determines that caption display area 303 protrudes from image display area 302, display area detection section 107 sends the combined image data to correction information processing section 108.

When correction information processing section 108 receives the combined image data from display area detection section 107, correction information processing section 108 computes a correction amount for which the length of the lower base of image display area 302 is changed to the length of the longer side of caption display area 303 (at step 203). Thereafter, correction information processing section 108 sends information of the computed correction amount to correction pixel conversion section 105.

When correction pixel conversion section 105 receives the information of the correction amount from correction information processing section 108, correction pixel conversion section 105 converts pixels for the image data such that the length of the lower base of image display area 302 is increased based on the information of the correction amount (at step 204). At this point, the shape of image display area 302 is kept trapezoidal. The image data in which pixels have been converted are output from correction pixel conversion section 105 and then combined with the caption data that are output from caption signal decoding section 103. The combined image data in which the image data and the caption data have been combined are input to each of image display section 106 and display area detection section 107.

The image of the combined image data is displayed on fixed pixel panel 301 as shown in FIG. 4(b). As shown in FIG. 4(b), a part of the lower side of caption display area 303 rectangularly protrudes from image display area 302.

Returning to step 201, display area detection section 107 detects caption display area 303 and image display area 302 from the input combined image data. Thereafter, display area detection section 107 determines whether or not caption display area 303 fits into image display area 302 (at step 202). If display area detection section 107 determines that caption display area 303 protrudes from image display area 302, display area detection section 107 sends the combined image data to correction information processing section 108.

When correction information processing section 108 receives the combined image data from display area detection section 107, correction information processing section 108 computes a correction amount to enable the lower base of image display area 302 to be spread in a vertically downward direction such that the lower base matches the lower longer side of caption display area 303 (at step 203). Thereafter, correction information processing section 108 sends information of the computed correction amount to correction pixel conversion section 105.

When correction pixel conversion section 105 receives the information of the correction amount from correction information processing section 108, correction pixel conversion section 105 converts pixels for the image data such that the lower base of image display area 302 is spread in a vertically lower direction based on the information of the correction amount (at step 204). At this point, the shape of image display area 302 is kept trapezoidal. The image data in which pixels have been converted are output form correction pixel conversion section 105 and then combined with the caption data that are output from caption signal decoding section 103. Combined image data in which the image data and the caption data have been combined are input to each of image display section 106 and display area detection section 107.

The image of the combined image data is displayed on fixed pixel panel 301 as shown in FIG. 4(c). As shown in FIG. 4(c), caption display area 303 is contained in image display area 302. Returning to step 201, display area detection section 107 detects caption display area 303 and image display area 302 from the combined image data. Thereafter, display area detection section 107 determines whether or not caption display area 303 fits into image display area 302 (at step 202). If display area detection section 107 determines that caption display area 303 is contained in image display area 302, display area detection section 107 does not send the combined image data to correction information processing section 108.

Although the case in which the correction process for the image display area is performed in two stages was described in detail, the correction process described with reference to FIG. 4 may be performed in one stage.

The caption display area may vary depending on the amount of textual information that is displayed rather than stay fixed like the on-screen-display (OSD). In this case, since the projector needs to perform the correction process for the image display area based on each image signal, whenever an image signal is input, the projector performs the process represented by the flow chart shown in FIG. 3. As a result, the image display area is automatically corrected without necessity of user's intervention to enlarge or reduce the screen.

However, if the caption display area does not largely vary because of an image of a movie recorded on a DVD or an image of a recorded TV program, once the projector performs the process represented by the flow chart shown in FIG. 3 based on a reference image signal, the process represented by the flow chart shown in FIG. 3 for an input image signal may be omitted.

Since the projector according to this embodiment changes the shape or size of the image display area according to an instruction that the user inputs, even if the caption display area protrudes from the image display area, the projector restricts changing the shape or size of the image display area such that the caption display area fits into the image display area.

### Second Embodiment

According to the first embodiment, if the caption display area protrudes from the image display area, as was described with reference to FIG. 2, an image of combined image data is projected on the screen until the caption display area fits into the image display area. By contrast, according to a second embodiment, the image is projected on the screen after the caption display area fits into the image display area.

Here, the structure of the projector according to this embodiment will be described. Since the projector according to this embodiment is similar to the projector according to the first embodiment except for the structure of the image signal processing section, a detailed description for other than the image signal processing section will be omitted. In addition, similar structural portions to those according to the first embodiment are denoted by similar reference numerals and their detailed description will be omitted.

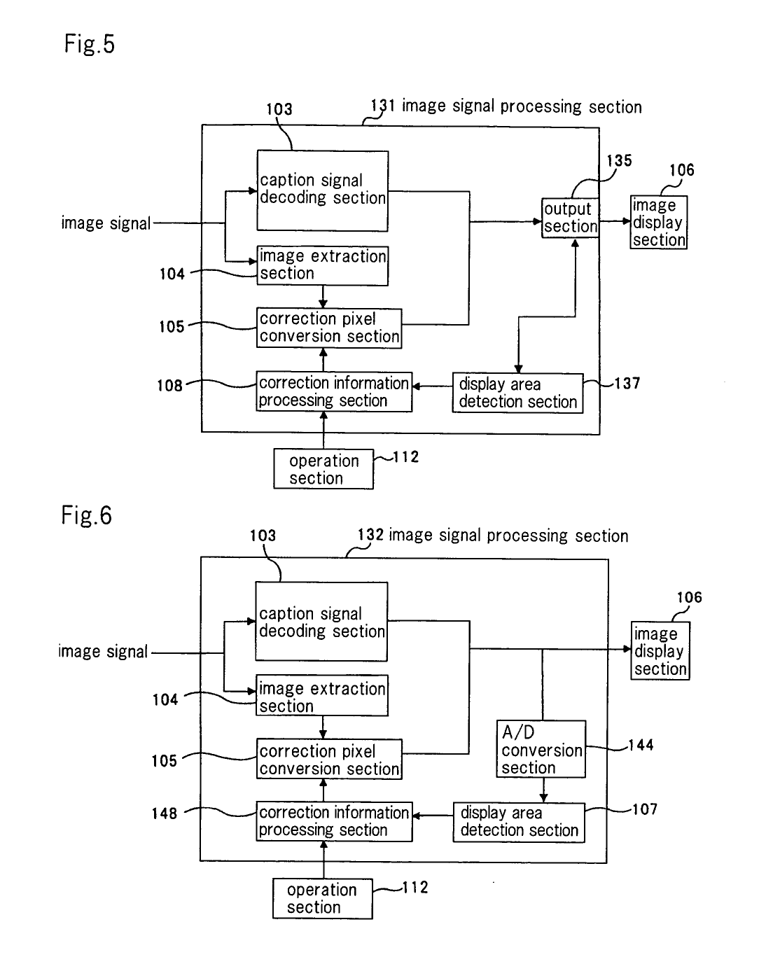

FIG. 5 is a block diagram showing an exemplary structure of the image signal processing section of the projector according to this embodiment. As shown in FIG. 5, image signal processing section 131 according to this embodiment is provided with output section 135 between a portion at which an output of caption signal decoding section 103 and an output of correction pixel conversion section 105 are connected and image display section 106.

If the caption display area protrudes from the image display area, display area detection section 137 operates in the same manner as does display area detection section 107 according to the first embodiment. If the caption display area fits into the image display area, display area detection section 137 sends a control signal that causes combined image data to be output to image display section 106 to output section 135.

Unless output section 135 receives the control signal from display area detection section 137 even if the combined image data are input to output section 135, output section 135 does not output the combined image data to image display section 106. When output section 135 receives the control signal from display area detection section 137, output section 135 outputs the combined image data that have been input to image display section 106.

Next, with reference to the flow chart shown in FIG. 3, the operation of image signal processing section 131 according to this embodiment will be described.

Image signal processing section 131 detects the caption display area and the image display area from the combined image data of the image signal and if the caption display area protrudes from the image display area, image signal processing section 131 repeats the process from step 201 to step 204 until the caption display area fits into the image display area. If image signal processing section 131 determines that the caption display area fits into the image display area at step 202, image signal processing section 131 causes the combined image data to be output from output section 135 to image display section 106.

According to this embodiment, even if the user excessively changes the shape or size of the image display area, the image is projected on the screen such that the caption display area fits into the image display area.

According to this embodiment, output section 135 is contained in image signal processing section 131; however, output section 135 may be disposed between image signal processing section 131 and image display section 106 or contained in image display section 106.

### Third Embodiment

According to this embodiment, the image display area is a white display so as to easily detect the outer edge of the image display area. This embodiment is especially effective if an analog image signal is used. The state that in which outer edge of the image display area is difficult to detect occurs, for example, if the contents of an image are a person or a substance that appear only at the center of the image display area and the background is black.

Here, the structure of the projector according to this embodiment will be described. Since the projector according to this embodiment is similar to the projector according to the first embodiment except for the structure of the image signal processing section, a detailed description for other than the image signal processing section will be omitted. In addition, similar portions to those according to the first embodiment are denoted by similar reference numerals and their detailed description will be omitted. In this embodiment, it is assumed that an analog image signal is used.

FIG. 6 is a block diagram showing an exemplary structure of the image signal processing section of the projector according to this embodiment.

As shown in FIG. 6, image signal processing section 132 according to this embodiment is provided with A/D conversion section 144 between a portion at which an output of caption signal decoding section 103 and an output of correction pixel conversion section 105 are connected and display area detection section 107. A/D conversion section 144 converts an analog signal of input combined image data into a digital signal and outputs the digital signal to display area detection section 107.

When correction information processing section 148 receives combined image data from display area detection section 107, correction information processing section 148 sends a control signal that causes the combined image data to be a white display to correction pixel conversion section 105. The state that “white display” denotes that all the levels of pixels of RGB are the maximum. In addition, correction information processing section 148 computes a correction amount in the same manner as in the first embodiment and sends the obtained compensation amount to correction pixel conversion section 105.

When at least either the instruction is input from correction pixel conversion section 105 through operation section 112 or the correction amount is input from correction information processing section 148 to correction pixel conversion section 105, it generates image data in which pixels of the image display area are converted based on the instruction or correction amount that has been input. When correction pixel conversion section 105 receives the control signal from correction information processing section 148, correction pixel conversion section 105 corrects the image data in which pixels have been converted such that the entire image display area is the white display.

Next, with reference to the flow chart shown in FIG. 3, the operation of image signal processing section 132 according to this embodiment will be described.

Image signal processing section 132 detects a caption display area and an image display area from combined image data of an image signal and if the caption display area protrudes from the image display area, image signal processing section 132 causes the entire image display area to be the white display. Then, image signal processing section 132 repeats the process from step 201 to step 204 until the caption display area fits into the image display area. When image signal processing section 132 determines that the caption display area fits into the image display area at step 202, image signal processing section 132 stops causing the image display area to be the white display and outputs the combined image data to image display section 106.

According to this embodiment, when the user performs the process that forms the image display area in a trapezoidal shape or enlarges or reduces the image display area, if the caption display area protrudes from the image display area, the entire image display area is the white display. Thus, even if the image display area is difficult to distinguish because of the contents of an image, since the image display area is the white display, the region in which the image is displayed can be easily detected.

### Fourth Embodiment

According to this embodiment, an image display area is easily detected in a manner different from that according to the third embodiment. A projector according to this embodiment projects a white image on a screen and then the image is captured by an imaging device so as to detect an image display area.

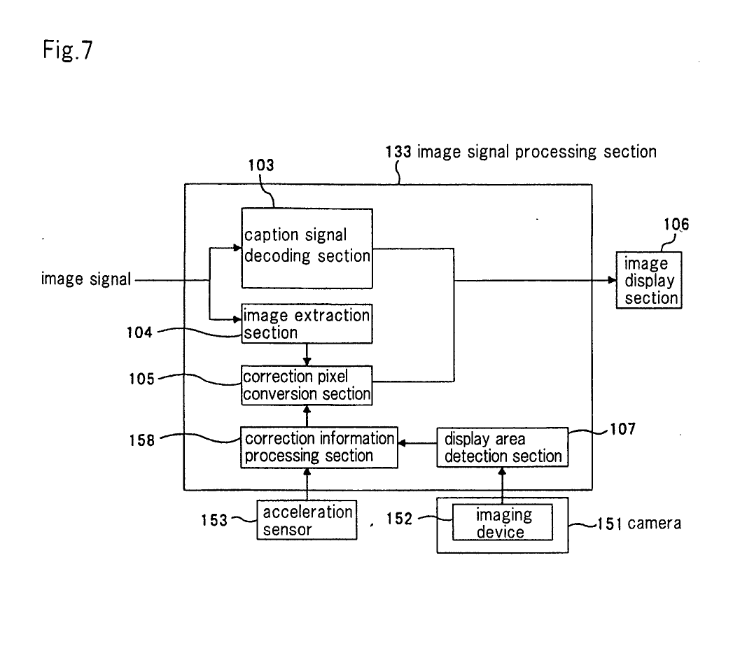

FIG. 7 is a block diagram showing principal portions of the projector according to this embodiment. Similar structural portions to those according to the first embodiment are denoted by similar reference numerals and their detailed description will be omitted.

The projector according to this embodiment is provided with image signal processing section 133 shown in FIG. 7 instead of image signal processing section 110 shown in FIG. 1; acceleration sensor 153 instead of operation section 112; and camera 151. Camera 151 includes imaging device 152 that captures an image projected on screen 120 shown in FIG. 1.

Acceleration sensor 153 detects the inclination of image display section 106 of projector 101 to a direction horizontal to the ground. A detected value of acceleration sensor 153 at which projector 101 was positioned at a flat place has been pre-registered as a standard value thereof. When projector 101 is tilted, acceleration sensor 153 measures an inclination rate that is equivalent to the angle of inclination and sends the value of the inclination rate to correction information processing section 158.

When correction information processing section 158 receives the value of the inclination rate from acceleration sensor 153, correction information processing section 158 notifies correction pixel conversion section 105 of an instruction that causes the image display area to be formed in a trapezoidal shape. On the other hand, when correction information processing section 158 receives combined image data from display area detection section 107, correction information processing section 158 sends a control signal that causes the image display area to be a white display to correction pixel conversion section 105. In addition, correction information processing section 158 computes a correction amount in the same manner as in the first embodiment and sends the obtained correction amount to correction pixel conversion section 105.

When at least either the instruction is input to correction pixel conversion section 105 through operation section 112 or the correction amount is input from correction information processing section 158 to correction pixel conversion section 105 in the same manner as in the first embodiment, correction pixel conversion section 105 generates image data in which pixels of the image display area are converted based on the instruction or correction amount that has been input. On the other hand, when correction pixel conversion section 105 receives the control signal from correction information processing section 158, correction pixel conversion section 105 corrects the image data in which pixels have been converted such that the entire image display area is the white display.

Next, with reference to the flow chart shown in FIG. 3, the operation of image signal processing section 133 according to this embodiment will be described.

If the user tilts the projector and thereby the caption display area protrudes from the image display area on an image displayed on the screen, the image is input to image signal processing section 133 through imaging device 152. If image signal processing section 133 determines that caption display area protrudes from the image display area, image signal processing section 133 causes the entire image display area to be the white display. Thereafter, image signal processing section 133 repeats the process from step 201 to step 204 until the caption display area fits into the image display area. If image signal processing section 132 determines that the caption display area fits into the image display area at step S202, image signal processing section 132 stops causing the image display area to be the white display and outputs the combined image data to image display section 106.

According to this embodiment, if the projector is tilted, the inclination detection section, such as an acceleration sensor, detects the inclination and thereby the projector forms an image projected on the screen in a trapezoidal shape. Since the image is formed in a trapezoidal shape, if the caption display area protrudes from the image display area, the entire image display area is the white display. Even if the image display area is difficult to distinguish because of the contents of an image, when the image display area is the white display, the region in which the image is displayed can be easily detected.

According to this embodiment, when the projector is tilted, the user does not need to cause an image to be formed in a trapezoidal shape and since the image is formed in a trapezoidal shape, even if the caption display area protrudes from the image display area, the caption display area automatically fits into the image display area.

Although the projector according to the fourth embodiment is provided with acceleration sensor 153 as shown in FIG. 7, the projector may be provided with operation section 112 shown in FIG. 1 instead of acceleration sensor 153. On the contrary, the projector according to any one of the first to third embodiments, may be provided with acceleration sensor 153 instead of operation section 112. In this case, the image signal processing section is provided with correction information processing section 158 instead of correction information processing section 108.

According to the third and fourth embodiments, the case in which an image display area is detected by causing it to be a white display was described; however, the image display area may be detected based on an input image signal in the same manner as in the first embodiment.

In addition, the third or fourth embodiment may be applied to the first embodiment, whereas the second embodiment may be applied to the third or fourth embodiment.

While the invention has been particularly shown and described with reference to exemplary embodiments and examples thereof, the invention is not limited to these embodiments and examples. It will be understood by those of ordinary skill in the art that various changes in form and details may be made therein without departing from the spirit and scope of the present invention as defined by the claims.

1. An image display device, comprising:
a caption signal decoding section that extracts a caption signal from an image signal that is input;
an image extraction section that extracts image data other than said caption signal from said image signal;
a correction pixel conversion section that changes an image display area for the image data that are input from said image extraction section according to an instruction that causes a shape or size of the image display area to be changed, that outputs corrected image data that comprise image data in which the image display area has been changed, that restricts changing said image display area based on a correction amount that is input, and that outputs corrected image data that comprise image data in which changing of the image display area has been restricted;
an image display section that outputs an image of combined image data that comprise data in which said caption signal that has been output from said caption signal decoding section and said correction image data that have been output from said correction pixel conversion section are combined;
a display area detection section that detects a caption display area that comprises a display area for textual information of said caption signal and said image display area from said combined image data that are input and outputs the combined image data if the caption display area does not fit into the image display area; and
a correction information processing section that computes said correction amount to enable said caption display area to fit into said image display area for said combined image data received from said display area detection section and sends said correction amount to said correction pixel conversion section.

2. The image display device according to claim 1, further comprising:
an output section that is connected to each of said image display section and said display area detection section, controls an input of said combined image data to said image display section, and outputs the combined image data to said image display section according to a control signal that causes the combined image data to be output, the control signal being received from said display area detection section,
wherein if said caption display area fits into said image display area, said display area detection section sends said control signal to said output section.

3. The image display device according to claim 1,
wherein said correction information processing section sends a control signal that causes said image display area to be a white display to said correction pixel conversion section based on the combined image data received from said display area detection section.

4. The image display device according to claim 3, further comprising:
an A/D conversion section that converts an analog signal of said combined image data into a digital signal and sends the digital signal to said display area detection section if said image signal comprises the analog signal.

5. An image display device, comprising:
a caption signal decoding section that extracts a caption signal from an image signal that is input;
an image extraction section that extracts image data other than said caption signal from said image signal;
a correction pixel conversion section that changes an image display area for the image data that are input from said image extraction section according to an instruction that causes a shape of the image display area to be formed in a trapezoidal shape, that outputs corrected image data that comprise image data in which the image display area has been changed, that restricts changing said image display area based on a correction amount that is input, and that outputs corrected image data that comprise image data in which changing of the image display area has been restricted;
an image display section that outputs an image of combined image data that comprise data in which said caption signal that has been output from said caption signal decoding section and said correction image data that have been output from said correction pixel conversion section are combined;
an inclination detection section that detects an angle of an inclination of said image display section to a direction horizontal to a ground and outputs a value of the detected angle of the inclination;
an imaging device that captures a combined image of said combined image data that are output from said image display section and outputs the combined image;
a display area detection section that detects a caption display area that is a display area for textual information of said caption signal and said image display area from said combined image that is input from said imaging device and outputs the combined image if the caption display area does not fit into the image display area; and
a correction information processing section that notifies said image pixel conversion section of an instruction that causes said image display area to be formed in a trapezoidal shape based on the value of the angle of said inclination received from said inclination detection section, computes said correction amount for said combined image received from said display area detection section such that said caption display area fits into said image display area, and sends the correction amount to said correction pixel conversion section.

6. An image processing method of an image display device, comprising:
extracting a caption signal and image data other than the caption signal from an image signal that is input;
generating first corrected image data that are image data in which an image display area that comprises a display area of an image of said image data is changed according to an instruction that causes a shape or a size of the image display area to be changed;
detecting said image display area and a caption display area that comprises an area in which textual information of said caption signal is displayed from combined image data in which said first correction image data and said caption signal are combined;
computing a correction amount to enable said caption display area to fit into said image display area if said caption display area does not fit said image display area;
generating second corrected image data that are image data in which changing of said image display area is restricted based on said correction amount; and
outputting combined image data in which said caption signal and said second combined image data are combined.

7. The image display device according to claim 2,
wherein said correction information processing section sends a control signal that causes said image display area to be a white display to said correction pixel conversion section based on the combined image data received from said display area detection section.

8. The image display device according to claim 7, further comprising:
an A/D conversion section that converts an analog signal of said combined image data into a digital signal and sends the digital signal to said display area detection section if said image signal comprises the analog signal.
